(19) United States
(12) Patent Application Publication
(10) Pub. No.: US 2024/0265379 A1
(43) Pub. Date: Aug. 8, 2024

(54) TOKEN GENERATION APPARATUS, TOKEN GENERATION METHOD, AND TOKEN MANAGEMENT PROGRAM

(71) Applicant: double jump.tokyo Inc., Tokyo (JP)

(72) Inventors: Hironobu UENO, Tokyo (JP); Ryo MANZOKU, Tokyo (JP)

(73) Assignee: double jump.tokyo Inc., Tokyo (JP)

(21) Appl. No.: 18/042,491

(22) PCT Filed: Sep. 29, 2021
(86) PCT No.: PCT/JP2021/035969

§ 371 Date: Feb. 22, 2023

(51) Int. Cl. G06Q 20/38

(52) U.S. Cl. CPC G06Q 20/3825

(57) ABSTRACT

A token generation apparatus configured to generate a token comprising a smart contract that includes: a non-paid token consumption history storage unit configured to store history of consumption of assets in a token that is different from a paid token issued at a predetermined value, the token relating to the assets that relate to the paid token; and a consumption processing unit configured to accept designation of a consumption amount of the assets and configured to store, into the history of consumption, information indicating that the assets of the designated consumption amount are consumed in the token.

### CROSS-REFERENCE TO RELATED APPLICATIONS

This application claims priority of International Application No. PCT/JP2021/035969, filed on Sep. 29, 2021, and Japanese Patent Application No. JP 2022-541972 filed on Sep. 29, 2021, the contents of which are incorporated herein.

### TECHNICAL FIELD

The present disclosure relates to a token generation apparatus, a token generation method, and a token management program.

### BACKGROUND

There have been widely executed transactions of electronic assets using smart contracts. For example, there has been known Ethereum, which is a platform capable of executing transactions of assets between users with smart contracts and issuing tokens that allow for sharing of the history of the e transactions between nodes (for example, Japanese Patent Application Publication No. 2019-160316). Ethereum is a platform for constructing decentralized applications and smart contracts. Smart contracts are implemented on a blockchain so as to automatically implement a protocol of contract and the like.

A token implemented with a smart contract as described above can be issued to a user for value continuously at a fixed price as an instrument for a service provider to provide a predetermined service, for example prepaid payment instrument). In this case, in addition to the token corresponding to a prepaid payment instrument that is issued for value (a paid token), the service provider can give the user a token that is issued for free as an incentive or a reward purpose (a non-paid token).

However, when the user uses a service, it is favorable to allow for a use of the paid token and the non-paid token without distinction in the appearances. On the other hand, in some cases, the service provider needs to treat information on the prepaid payment instrument, that is, the paid token, distinctively from the non-paid token (for example, it is necessary to notify the unused balance of a prepaid payment instrument to the director-general of a local finance bureau and the like), and the paid and non-paid tokens need to be managed such that each can be referred objectively.

The present disclosure is made in view of the background as described above, and an object thereof is to provide a token generation apparatus, a token generation method, and a token management program that are capable of providing a token that is issued for value continuously at a fixed price and a token that is issued for free.

### SUMMARY

An aspect of the present disclosure to solve the above object is a token generation apparatus configured to generate a token comprising a smart contract that includes: a non-paid token consumption history storage unit configured to store history of consumption of assets in a token that is different from a paid token issued at a predetermined value, the token relating to the assets that relate to the paid token; and a consumption processing unit configured to accept designation of a consumption amount of the assets and configured to store, into the history of consumption, information indicating that the assets of the designated consumption amount are consumed in the token.

Another aspect of the present disclosure is a token generation method implemented by an information processing device, comprising: generating a token comprising a smart contract, the smart including a non-paid token consumption history storage unit that stores history of consumption of assets in a token that is different from a paid token issued at a predetermined value, the token relating to the assets that relate to the paid token, and a consumption processing unit that accepts designation of a consumption amount of the assets and stores, into the history of consumption, information indicating that the assets of the designated consumption amount are consumed in the token.

Another aspect of the present disclosure is a token management program that causes an information processing device to execute: non-paid token consumption history store processing to store history of consumption of assets in a token that is different from a paid token issued at a predetermined value, the token relating to the assets that relate to the paid token; and consumption processing to accept designation of a consumption amount of the assets and store, into the history of consumption, information indicating that the assets of the designated consumption amount are consumed in the token.

### Advantageous Effects of the Disclosure

According to the present disclosure, it is possible to provide a token that is issued for value continuously at a fixed price and a token that is issued for free.

Problems, configurations, and effects other than that described above will become apparent by the following descriptions of embodiments.

### BRIEF DESCRIPTION OF DRAWINGS

FIG. 1 is a diagram illustrating an example of a configuration of a token management system according to the present embodiment.

FIG. 2 is a diagram describing an example of main functionalities of a smart contract in a token (a transferable token and an untransferable token).

FIG. 3 is a diagram illustrating an example of hardware included in each node.

FIG. 4 is a flowchart describing an example of new issuance processing.

FIG. 5 is a flowchart describing an example of additional issuance processing.

FIG. 6 is a flowchart describing an example of consumption processing.

FIG. 7 is a flowchart describing an example of non-paid token information confirmation processing.

FIG. 8 is a flowchart describing an example of paid and non-paid token information confirmation processing.

### DETAILED DESCRIPTION OF PREFERRED EMBODIMENTS

### Example 1 (Embodiment 1)

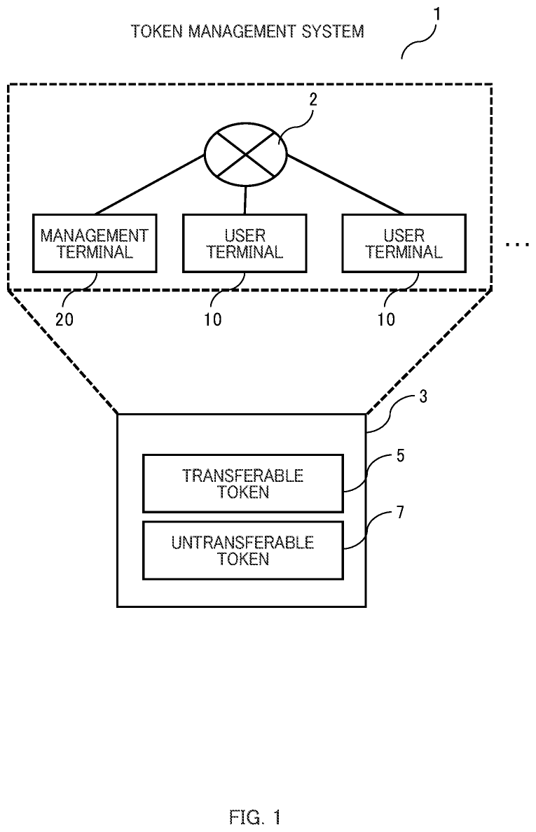

FIG. 1 is a diagram illustrating an example of a configuration of a token management system 1 according to the present embodiment. This token management system 1 includes a management terminal 20 (a token generation apparatus) that issues a token 3 and multiple user terminals 10 that use the issued token 3. The management terminal 20 and each user terminal 10 are associated with one or more accounts (identifiers).

The management terminal 20 and each user terminal 10 share information on an asset by the token 3, which is blockchain data recording the disposition history of the asset. Specifically, this token 3 is shared as an NFT (Non Fungible Token) having a different value depending on an attribute of the asset. The type of an asset is not particularly limited and may be information on a right to perform predetermined processing or action or may be various media such as an image, music, text, and a game item, for example.

The user terminal 10 and the management terminal 20 manage two types of the tokens 3, which are a transferable token 5 and an untransferable token 7, in relation to an asset. The transferable token 5 is a paid asset token that is issued from the management terminal 20 based on predetermined payment and is transferable between accounts.

Additionally, in the present embodiment, the transferable token 5 functions as a prepaid payment instrument that is issued (sold) continuously (without limitation of period) at a fixed value with no variation in price. However, it is possible to configure the token management system 1 of the present embodiment even if the transferable token 5 has a limitation of period or a variation in price. Note that, the transferable token 5 is implementable with a standard functionality (ERC20 or the like) implemented on Ethereum, for example.

On the other hand, although the untransferable token 7 is a token relating to the same type of an asset as the asset relating to the transferable token 5, the untransferable token 7 is issued from the management terminal 20 as a different token from the transferable token 5. The untransferable token 7 is a non-paid token that does not need payment for the issuance. However, unlike the transferable token 5, the untransferable token 7 is not allowed for transfer of a token (for example, transaction of a token) between accounts and is a specific asset token that can be consumed for a predetermined purpose by only an account that receives the issuance.

Note that, a timing of the issuance the untransferable token 7 may be the same as the issuance of the transferable token 5, may be before the issuance of the transferable token 5, or may be after the issuance of the transferable token 5.

The management terminal 20 and each user terminal 10 execute processing relating to those tokens (the asset therein) with a smart contract that is a program.

The management terminal 20 is an information processing device such as a server device. The management terminal 20 issues the transferable token 5 and the untransferable token 7 to an account of the user terminal 10.

The user terminal 10 is an information processing device such as a personal computer and a smartphone, for example. The user terminal 10 uses the token issued by the management terminal 20 to execute transfer (transaction) or consumption of the asset held by the account relating to the user terminal 10.

The management terminal 20 and each user terminal 10 are coupled with each other by a wired or wireless communication network 2 such as a LAN (Local Area Network), a WAN (Wide Area Network), the Internet, or an exclusive line, for example.

The above-described token management system 1 is implemented by using Ethereum, for example; however, the implementation may be achieved by using another platform as long as the functionalities described below are implementable.

Next, functionalities that the user terminal 10 and the management terminal 20 have are described.

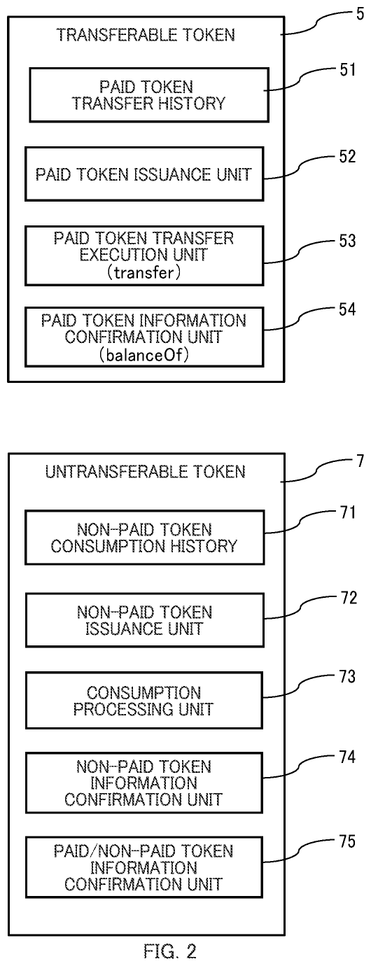

FIG. 2 is a diagram describing an example of main functionalities of the smart contract in the token 3 (the transferable token 5 and the untransferable token 7) stored in the user terminal 10 and the management terminal 20 (hereinafter, referred to as a node).

First, the transferable token 5 stores paid token transfer history 51. The paid token transfer history 51 is information in which the history of transfer the transferable token 5 between accounts (the history of relocation and transfer of ownership) is recorded. In the present embodiment, the paid token transfer history 51 is configured as a part of blockchain data. The paid token transfer history 51 includes the history of a relocation source account of the transferable token 5, a relocation destination account, and an amount (the number) of the relocated transferable tokens 5, for example.

Next, the transferable token 5 has functionalities of a paid token issuance unit 52, a paid token transfer execution unit 53, and a paid token information confirmation unit 54.

The paid token issuance unit 52 generates the transferable token 5 and issues the generated transferable token 5 to the user terminal 10. Information on the issued transferable token 5 is recorded in the paid token transfer history 51. Note that, in the present embodiment, the paid token issuance unit 52 is executed only when there is an execution request from an account relating to the management terminal 20. That is, the issuance of the transferable token 5 can be executed only by a management account (or the management terminal 20).

The paid token transfer execution unit 53 executes transfer (transaction) of a designated amount of the transferable tokens 5 between designated accounts. For example, the paid token transfer execution unit 53 relocates ownership of the designated amount (number) of the transferable tokens 5 from the relocation source account to the designated relocation destination account. The history of the transfer of the transferable tokens 5 is recorded in the paid token transfer history 51. The paid token transfer execution unit 53 is the transfer function on Ethereum, for example.

The paid token information confirmation unit 54 obtains information on the transferable tokens 5 that the designated account currently possesses (for example, information on the current balance) and transmits the obtained information to the account (the relating node). The paid token information confirmation unit 54 is the balanceOf function on Ethereum, for example.

Note that, at least any one of the above-described paid token transfer history 51, paid token issuance unit 52, paid token transfer execution unit 53, and paid token information confirmation unit 54 may be implemented as the smart contract (or data) in the untransferable token 7.

Next, the untransferable token 7 stores non-paid token consumption history 71. The non-paid token consumption history 71 is information in which the history of obtainment (issuance) and consumption of the untransferable token 7 of each account is recorded. In the present embodiment, the non-paid token consumption history 71 is configured as a part of blockchain data. The non-paid token consumption history 71 includes the history of an issuance source account of the untransferable token 7, an account that obtains the untransferable token 7, an amount (the number) of the consumed untransferable tokens 7, and a consumption purpose, for example.

The untransferable token 7 includes a non-paid token issuance unit 72, a consumption processing unit 73, a non-paid token information confirmation unit 74, and a paid and non-paid token information confirmation unit 75.

The non-paid token issuance unit 72 generates the untransferable token 7 and issues the generated untransferable token 7 to the user terminal 10. Information on the issued token is recorded in the non-paid token consumption history 71. Note that, in the present embodiment, non-paid token issuance unit 72 is executed only when there is an execution request from an account relating to the management terminal 20. That is, the issuance of the untransferable token 7 can be executed only by the management account (or the management terminal 20). The non-paid token issuance unit 72 may be executed together with the paid token issuance unit 52.

The consumption processing unit 73 accepts designation of the consumption amount of the untransferable tokens 7 and executes the consumption of the designated consumption amount in relation to the untransferable tokens 7. This information on the consumption is recorded in the non-paid token consumption history 71.

Note that, in the present embodiment, the consumption processing unit 73 is capable of executing also the consumption relating to the transferable tokens 5. That is, the consumption processing unit 73 consumes the untransferable tokens 7 by a part of the designated consumption amount and updates the non-paid token consumption history 71, and consumes the transferable tokens 5 by the rest and updates the paid token transfer history 51.

In this case, the consumption processing unit 73 accepts designation of a consumption rule of the untransferable tokens 7 and performs the consumption of the untransferable tokens 7 and the transferable tokens 5 by the designated consumption amount distributed for each in accordance with the content of the designated consumption rule.

Next, the non-paid token information confirmation unit 74 accepts designation of an account and outputs information on the untransferable token 7 associated with the designated account.

The paid and non-paid token information confirmation unit 75 accepts designation of an account and outputs information that is a combination of information on the untransferable token 7 relating to the designated account and information on the transferable token 5: relating to the designated account (for example, a total value of a current possession amount of the untransferable tokens 7 and a current possession amount of the transferable tokens 5).

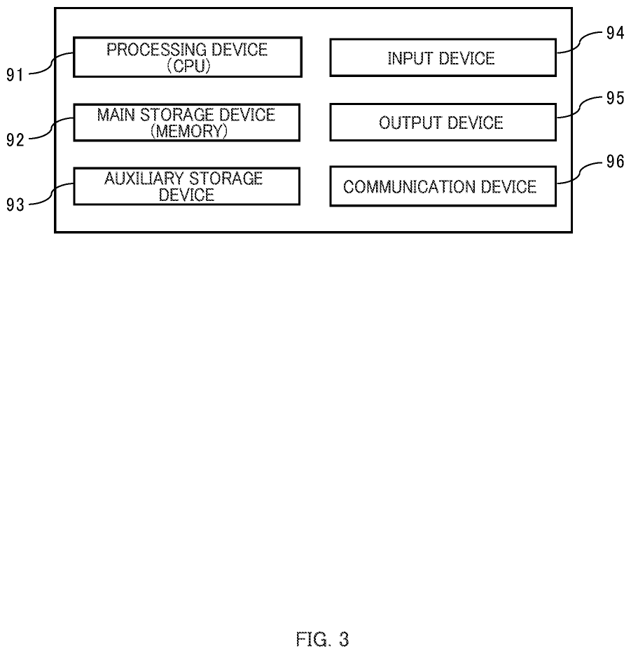

FIG. 3 herein is a diagram illustrating an example of hardware included in each node. Each node is an information processing device including a processing device 91 such as a CPU (Central Processing Unit), a main storage device 92 such as a RAM (Random Access Memory) and a ROM (Read Only Memory), an auxiliary storage device 93 such as an HDD (Hard Disk Drive) and an SSD (Solid State Drive), an input device 94 including a keyboard, a mouse, a touch panel, and the like, an output device 95 including a monitor (a display) and the like, and a communication device 96 establishing communication with another information processing device. Each functionality of the node is implemented by the hardware of the node or by the processing device 91 of the node that executes programs (smart contracts) stored in the main storage device 92 and the auxiliary storage device 93. Additionally, those programs are stored in a storage device such as a secondary storage device or a non-volatile semiconductor memory, a hard disk drive, and an SSD, or a non-temporal data storage medium readable by each node such as an IC card, an SD card, and a DVD, for example.

Subsequently, processing performed in the token management system 1 is described.

### New Issuance Processing

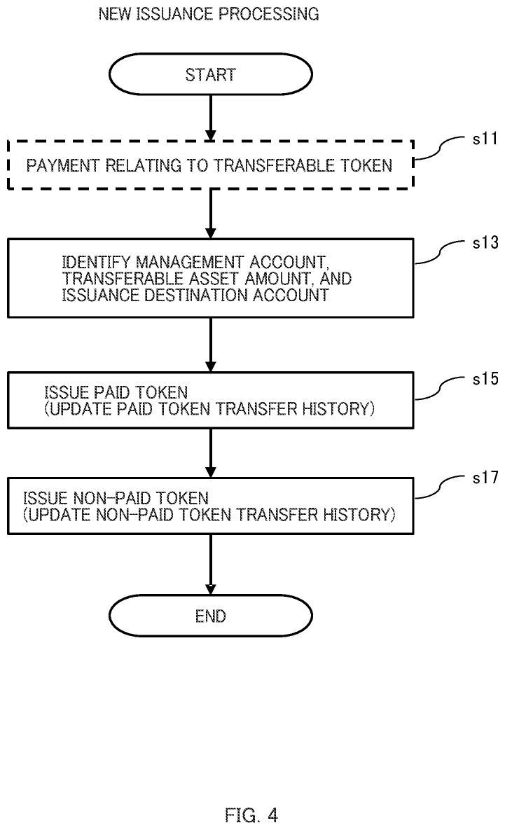

FIG. 4 is a flowchart describing an example of new issuance processing, which is processing to issue the untransferable token 7 with the transferable token 5.

The new issuance processing is started when a predetermined issuance request is inputted from an account relating to the management terminal 20 (the management account) to the transferable token 5 after payment processing for the transferable token 5 by an account relating to the user terminal 10 is executed (s110). The payment processing is, for example, credit card payment, electronic payment (for example, payment by ETH), and the like for purchasing the transferable token 5 which is executed by the management terminal 20 or a payment system associated with the management terminal 20 and is based on a request from the account relating to the user terminal 10. Note that, in the present embodiment, this payment amount is fixed.

First, the paid token issuance unit 52 identifies the management account, an amount (the number) of assets relating to the transferable token 5 to be issued, and an issuance destination account which are included in the issuance request from the management account (s13).

The paid token issuance unit 52 implements generation and issuance of the transferable token 5 by setting the transferable token 5 with the amount of the assets that is identified in s13 to the issuance destination account (s15). Specifically, the paid token issuance unit 52 adds to the paid token transfer history 51 the information on the management account, the amount of the assets relating to the transferable token 5, and the issuance destination account that is identified in s13. Thereafter, the content of the paid token transfer history 51 (the transferable token 5) is shared by all the nodes.

Next, the non-paid token issuance unit 72 implements generation and issuance of the untransferable token 7 by setting the untransferable token 7 with the amount of the assets that is identified in s13 to the issuance destination account (s17).

Specifically, the non-paid token issuance unit 72 calculates the amount (the issuance amount) of the assets relating to the untransferable token 7 based on the amount of the assets relating to the transferable token 5 that is identified in s13 (for example, a predetermined ratio of the issuance amount of the assets relating to the transferable token 5). Then, the non-paid token issuance unit 72 adds to the non-paid token consumption history 71 the information on the management account, the amount of the assets relating to the untransferable token 7, and the issuance destination account that is identified in s13. Thereafter, the content of the non-paid token consumption history 71 (the untransferable token 7) is shared by all the nodes. With that, the new issuance processing ends.

Note that, based on the issuance request, the non-paid token issuance unit 72 may accept designation of a specific amount of the assets relating to the untransferable token 7 to be issued.

Additionally, the processing in s17 may be performed subsequently after the issuance processing of the transferable token 5 in s15 or may be performed after a while after the processing in s15, or the processing may not be performed.

### Additional Issuance Processing

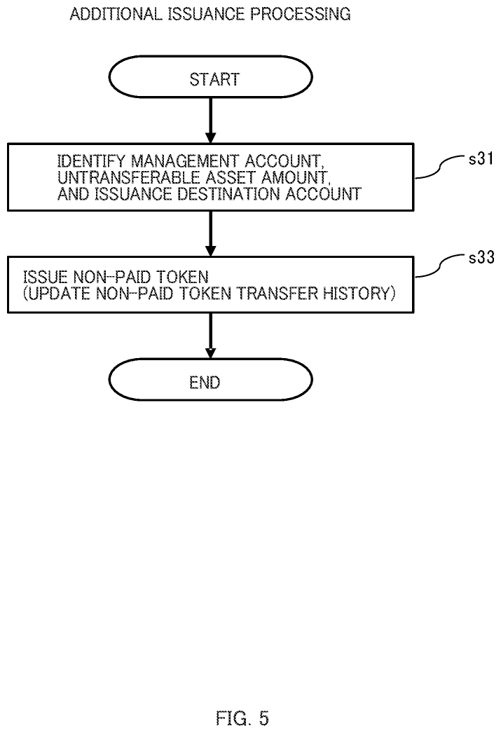

FIG. 5 is a flowchart describing an example of additional issuance processing, which is processing to add an asset to the untransferable token 7. The additional issuance processing is started after the issuance of the transferable token 5 in a case where a preset timing comes, in a case where the management terminal 20 executes predetermined processing, in a case where a predetermined issuance request is inputted from the management account to the untransferable token 7, or the like. However, the additional issuance processing may be executed before the issuance of the transferable token 5 (in that case, the type of the asset of the transferable token 5 needs to be identified).

The non-paid token issuance unit 72 identifies the management account, the amount of the assets relating to the untransferable token 7 to be issued, and the issuance destination account that are included in the issuance request (s31).

The non-paid token issuance unit 72 implements generation and issuance of the untransferable token 7 by setting the untransferable token 7 with the asset amount identified in s31 to the issuance destination account (s33). Specifically, the non-paid token issuance unit 72 adds to the non-paid token consumption history 71 the information on the management account, the amount of the assets relating to the untransferable token 7, and the issuance destination account that is identified in s31. Thereafter, the content of the non-paid token consumption history 71 (the untransferable token 7) is shared by all the nodes.

With that, the additional issuance processing ends.

### Consumption Processing

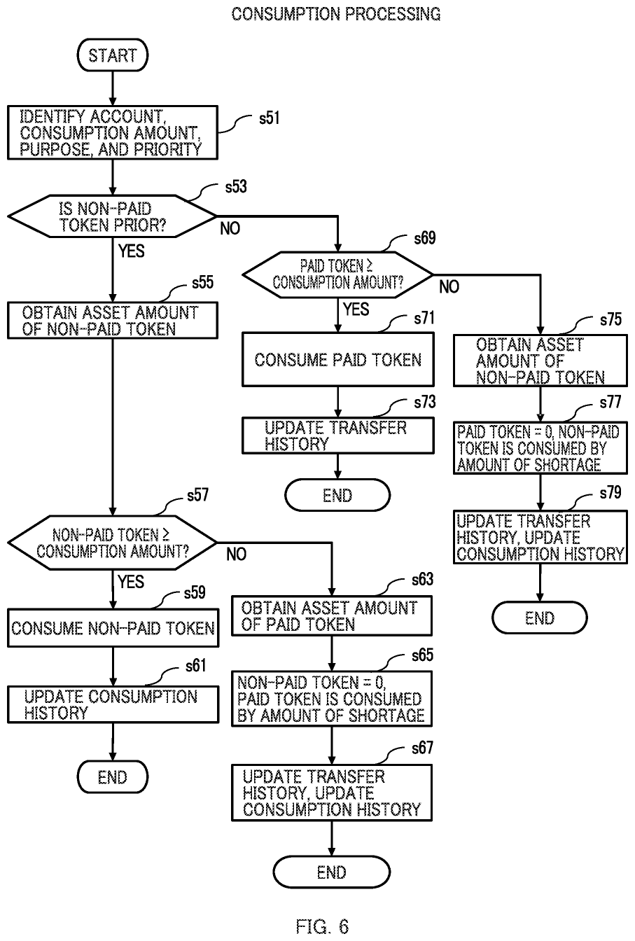

Next, FIG. 6 is a flowchart describing an example of consumption processing. For example, the consumption processing is started when a predetermined consumption instruction is inputted from the account relating to the user terminal 10 to the untransferable token 7.

The consumption processing unit 73 obtains information on the account and the consumption amount, the purpose, and the consumption rule (in this case, the degree of priority between the consumption in the transferable tokens 5 and the consumption in the untransferable tokens 7) of the assets that is included in the inputted consumption instruction (s51).

The consumption processing unit 73 determines whether to give more priority to the consumption in the untransferable tokens 7 than to the consumption in the transferable tokens 5 based on the information on a distribution method (s53). When priority is given to the consumption in the untransferable tokens 7 (s53: YES), the consumption processing unit 73 executes processing in s55, and when priority is not given to the consumption in the untransferable tokens 7 (s53: NO), the consumption processing unit 73 executes processing in s69, which is described later.

In s55, the consumption processing unit 73 obtains the current possession amount of the assets of the untransferable 7 token relating to the account identified in s51. Specifically, the consumption processing unit 73 obtains the current possession amount with reference to the non-paid token consumption history 71.

Then, the consumption processing unit 73 confirms whether the current possession amount of the assets of the untransferable token 7 is equal to or greater than the obtained consumption amount in s51 (s57).

When the current possession amount of the assets of the untransferable token 7 is equal to or greater than the obtained consumption amount in s51 (s57: YES), the consumption processing unit 73 executes processing in s59, and when the current possession amount of the assets of the untransferable token 7 is smaller than the obtained consumption amount in s51 (s57: NO), the consumption processing unit 73 executes processing in s63.

In s59, the consumption processing unit 73 reduces the possession amount of the assets relating to the untransferable token 7 by the consumption amount identified in s51. Specifically, the consumption processing unit 73 adds to the non-paid token consumption history 71 the history indicating that the possession amount of the assets relating to the untransferable token 7 of the account identified in s51 are reduced by the consumption amount identified in s51 for the purpose identified in s51.

Note that, the consumption processing unit 73 may execute predetermined processing indicated by the purpose identified in s51.

Thereafter, the content of the non-paid token consumption history 71 is shared by all the nodes (s61). With that, the consumption processing ends.

In s63, the consumption processing unit 73 obtains the current possession amount of the transferable tokens 5 relating to the account identified in s51 in the paid tokens. Specifically, the consumption processing unit 73 obtains the current possession amount of the assets relating to the transferable token 5 with reference to the paid token transfer history 51.

Then, the consumption processing unit 73 sets the possession amount of the assets relating to the untransferable token 7 to 0 (consumes all) and also consumes the transferable tokens 5 by the amount of the shortage assets by, for example, calling the paid token transfer execution unit 53 (s65).

Specifically, the consumption processing unit 73 adds to the non-paid token consumption history 71 the history indicating that the possession amount of the assets relating to the transferable token 5 of the account identified in s51 is reduced to 0 for the purpose identified in s51.

Then, the consumption processing unit 73 adds to the paid token transfer history 51 the history indicating that the possession amount of the assets relating to the transferable token 5 of the account identified in s51 is reduced by the shortage in the possession amount of the untransferable tokens 7 for the consumption amount identified in s51. In this case, in accordance with the purpose designated in s51, the consumption processing unit 73 may store the history of relocation of the reduced amount of assets to another account (that is, store the history of transfer).

Note that, the consumption processing unit 73 may confirm whether the current total possession amount of the assets relating to the transferable token 5 and the untransferable token 7 is equal to or greater than the consumption amount identified in s51, and when the total possession amount is smaller than the consumption amount identified in s51, error information may be outputted to end the consumption processing.

Additionally, the consumption processing unit 73 may execute predetermined processing indicated by the purpose identified in s51.

Thereafter, the paid token transfer history 51 and the non-paid token consumption history 71 are shared by all the nodes (s67). With that, the consumption processing ends.

On the other hand, in s69, the consumption processing unit 73 determines whether the possession amount of the assets relating to the transferable token 5 relating to the account identified in s51 is equal to or greater than the consumption amount identified in s51.

When the possession amount of the assets relating to the transferable token 5 is equal to or greater than the consumption amount identified in s51 (s69: YES), the consumption processing unit 73 executes processing in s71, and when the possession amount is smaller than the consumption amount identified in s51 (s69: NO), the consumption processing unit 73 executes processing in s75.

In s71, the consumption processing unit 73 reduces the possession amount of the assets relating to the transferable token 5 by the consumption amount identified in s51 by, for example, calling the paid token transfer execution unit 53. Specifically, the consumption processing unit 73 adds to the paid token transfer history 51 the history indicating that the possession amount of the assets relating to the transferable token 5 relating to the account identified in s51 is reduced by the consumption amount identified in s51 for the purpose identified in s51. Note that, in this case, in accordance with the purpose designated in s51, the consumption processing unit 73 may store the history of relocation of the subtracted amount of assets to another account (that is, store the history of transaction).

Note that, the consumption processing unit 73 may execute processing for the purpose identified in s51.

Thereafter, the paid token transfer history 51 is shared by all the nodes (s73). With that, the consumption processing ends.

In s75, the consumption processing unit 73 obtains the possession amount of the assets relating to the untransferable token 7 relating to the account identified in s51. Specifically, the consumption processing unit 73 obtains the current possession amount of the assets relating to the untransferable token 7 with reference to the non-paid token consumption history 71.

Then, the consumption processing unit 73 sets the possession amount of the assets relating to the transferable token 5 to 0 (consumes all) and also consumes the untransferable tokens 7 by the amount of the shortage by, for example, calling the paid token transfer execution unit 53 (s77).

Specifically, the consumption processing unit 73 adds to the paid token transfer history 51 the history indicating that the possession amount of the assets relating to the transferable token 5 relating to the account identified in s51 is reduced to 0 for the purpose identified in s51. Note that, in this case, in accordance with the purpose designated in s51, the consumption processing unit 73 may store into the paid token transfer history 51 the history of the relocation of the subtracted amount of assets to a predetermined account (that is, store the history of transaction).

Then, the consumption processing unit 73 adds to the non-paid token consumption history 71 the history indicating that the possession amount of the untransferable tokens 7 relating to the account identified in s51 is reduced by the shortage in the possession amount of the transferable tokens 5 for the consumption amount identified in s51 (residual of the consumption amount) for the purpose identified in s51.

Note that, the consumption processing unit 73 may execute predetermined processing for the purpose identified in s51.

Thereafter, the non-paid token consumption history 71 and the paid token transfer history 51 are shared by all the nodes (s79). With that, the consumption processing ends.

### Non-Paid Token Information Confirmation Processing

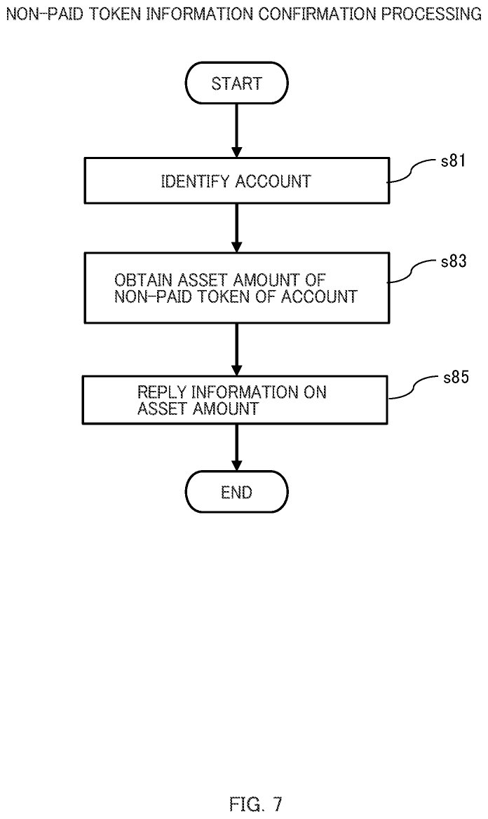

FIG. 7 is a flowchart describing an example of non-paid token information confirmation processing. The non-paid token information confirmation processing is started when a predetermined confirmation request is inputted from an account relating to the user terminal 10 or the management terminal 20 to the untransferable token 7, for example.

The non-paid token information confirmation unit 74 identifies the account included in the inputted confirmation request (s81). Note that, the non-paid token information confirmation unit 74 confirms whether the information on the untransferable token 7 is originally set to the account identified in s81, and when the information on the untransferable token 7 is not set, error information may be outputted to end the non-paid token information confirmation processing.

Then, the non-paid token information confirmation unit 74 obtains the information on the untransferable token 7 relating to the account identified in s81 (s83). Specifically, the non-paid token information confirmation unit 74 obtains from the non-paid token consumption history 71 the current possession amount of the assets relating to the untransferable token 7 relating to the account identified in s81.

Then, the non-paid token information confirmation unit 74 replies the information obtained in s83 to the account that inputs the confirmation request (s85). With that, the non-paid token information confirmation processing ends.

### Paid and Non-Paid Token Information Confirmation Processing

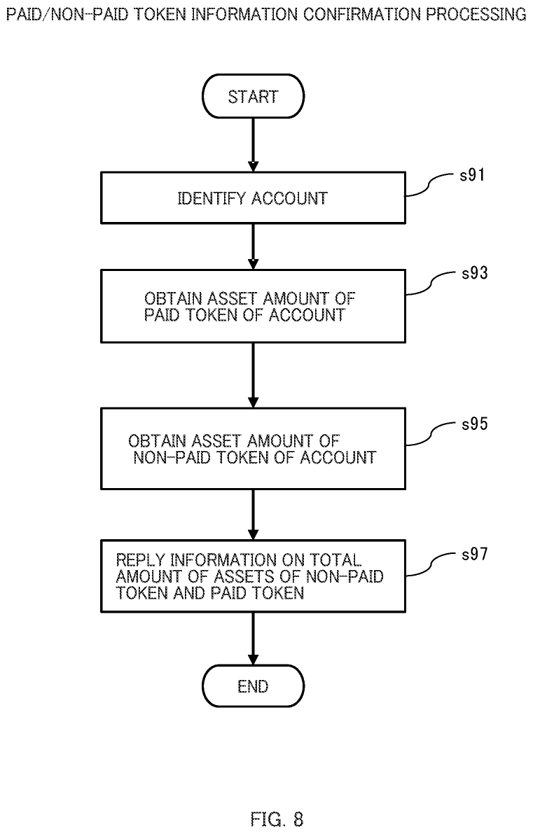

FIG. 8 is a flowchart describing an example of paid and non-paid token information confirmation processing. The paid and non-paid token information confirmation processing is started when a predetermined confirmation request is inputted from an account in the token management system 1 to the untransferable token 7, for example.

The paid and non-paid token information confirmation unit 75 identifies the account included in the inputted confirmation request (s91).

The paid and non-paid token information confirmation unit 75 obtains information on the transferable token 5 relating to the account identified in s91 (s93). Specifically, the paid and non-paid token information confirmation unit 75 obtains from the paid token transfer history 51 the current possession amount of the assets relating to the transferable token 5 relating to the account identified in s91.

Additionally, the paid and non-paid token information confirmation unit 75 obtains information on the untransferable token 7 relating to the account identified in s91 (s95). Specifically, the paid and non-paid token information confirmation unit 75 obtains from the non-paid token consumption history 71 the current possession amount of the assets relating to the untransferable token 7 relating to the account identified in s91.

Then, the paid and non-paid token information confirmation unit 75 replies information that is a combination of the information obtained in s93 and the information obtained in s95 to the account that inputs the confirmation request (s97).

For example, the paid and non-paid token information confirmation unit 75 replies information indicating a total value of the possession amount of the assets relating to the transferable token 5 obtained in s93 and the possession amount of the assets relating to the untransferable token 7 obtained in s97, or the respective possession amounts. With that, the paid and non-paid token information confirmation processing ends.

As described above, the management terminal 20 (the token generation apparatus) in the token management system 1 of the present embodiment generates and issues a token including a smart contract that stores the history of consumption of the asset in the untransferable token 7, which is a different token relating to the asset of the transferable token 5 issued at a fixed value (the non-paid token consumption history 71) and that consumes a designated consumption amount of assets and also stores the consumption of the consumption amount into the non-paid token consumption history 71.

With this, it is possible to treat the token (the untransferable token 7) of the asset that performs only consumption, in addition to the token (the transferable token 5) that allows for normal transfer in relation to an asset. That is, an asset obtained for value can be treated as the transferable token, and an asset obtained for free can be treated as the token that performs only consumption. With this, for example, it is possible to allow more users to purchase the paid transferable token 5 while using the untransferable token 7 to be obtained for free as an incentive. Additionally, since the transferable token 5 accompanied with the untransferable token 7 is replaceable with tokens relating to many other services, it is possible to acquire more users (for example, many users over multiple services) therethrough.

Moreover, since the transferable token 5 and the untransferable token 7 can be implemented based on the ERC20 standard, it is possible to define an asset token with a flexible specification in accordance with features of the contents in a case of treating an asset token unique for the contents such as the currency in a game. Furthermore, since the transferable token 5 and the untransferable token 7 can be implemented by using an already-existing platform such as Ethereum, no platformer needs to intermediate, and it is possible to keep the charge relating to the payment of the tokens to a minimum.

Additionally, since the transferable token 5 and the untransferable token 7 can be configured as a smart contract on a blockchain, the history of transfer and consumption of assets is definitely recorded, and also falsification by a third person is impossible.

Moreover, with the transferable token 5 at a continuous fixed price, a service provider relating to the asset can also issue the non-paid untransferable token 7 while issuing the transferable token 5 as a prepaid payment instrument that does not fall into cryptocurrency (for example, JPYC). On the other hand, the user can not only enjoy the merit of the untransferable token 7 as an incentive but also the user can enjoy the merit that the value of the transferable token 5 of an invested token is assured since the service provider has a duty to refund the amount equivalent to the transferable token 5 when a service relating to the transferable token 5 ends.

Thus, according to the management terminal 20 (the token generation apparatus) of the present embodiment, it is possible to provide a token that is issued for value continuously at a fixed price and a token that is issued for free.

Additionally, the untransferable token 7 in the token management system 1 of the present embodiment stores a part of the consumption amount of the designated assets into the non-paid token consumption history 71 in the untransferable token 7 and stores the residual as a consumption of the transferable token 5. Thus, since it is possible to consume the assets from each of the paid tokens and the non-paid tokens, the user can use assets freely based on the breakdown of the tokens held by the user.

Moreover, the user is able to use the transferable token 5 and the untransferable token 7 without distinction in the appearances, and on the other hand, the service provider can clearly distinguish both in data and, for example, can easily extract and grasp information on the unused balance of the transferable token 5 (the prepaid payment instrument) from the transferable token 5. With this, the service provider can easily perform operations such as notification of the unused balance of the transferable token 5 as the prepaid payment instrument to a predetermined government ministry.

Furthermore, the untransferable token 7 in the token management system 1 of the present embodiment accepts designation of the consumption rule of the untransferable token 7 and distributes the consumption of the designated consumption amount to the consumption of the untransferable token 7 and the transferable token 5 in accordance with the consumption rule. With the setting of the distribution method of the consumption of the paid token and the non-paid token (in the present embodiment, determination on the degree of priority between the untransferable token 7 and the transferable token 5) as described above, the user can select how to use the incentive.

Additionally, in the untransferable token 7 in the token management system 1 of the present embodiment, if the designated consumption amount is greater than the asset amount of the untransferable token 7 when the consumption priority of the untransferable token 7 is higher than the consumption priority of the transferable token 5, all the untransferable tokens 7 are consumed and also the transferable tokens 5 are consumed by the residual except the consumption amount of the untransferable tokens 7. Thus, with the higher priority particularly to the consumption of the non-paid token, the user can ensure the possibility of recovering the invested transferable tokens 5 as much as possible.

The descriptions of the embodiment described above are intended to facilitate understanding of the present disclosure and are not intended to limit the present disclosure. The present disclosure can be changed or improved without departing from the gist of the present disclosure, and also the present disclosure includes the equivalent thereof.

For example, a part of the smart contract of each node described in the present embodiment may be incorporated in another smart contract, or multiple smart contracts may be integrated into a single smart contract.

Additionally, a part of the functionalities of the smart contract of each node described in the present embodiment may be executed by a device independent from a blockchain, and the token (the smart contract) may cause the execution.

Moreover, the token management system 1 may treat multiple types of assets (treat the transferable token 5 and the untransferable token 7 in relation to each of the multiple types of assets).

Furthermore, the untransferable token 7 may be divided into two or more tokens in accordance with an attribute such as the type of the issuance destination account and intent of the consumption.

Additionally, the purpose of the consumption of each account may be designated in advance when issuing the untransferable token 7 so as to prevent the consumption by a purpose other than the designated purpose.

Moreover, in the present embodiment, the issuance of the untransferable token 7 is completely for free; however, the issuance of the untransferable token 7 may require any compensation other than the payment relating to the transferable token 5.

Furthermore, in the present embodiment, the paid and non-paid token information confirmation unit 75 outputs a total value of the possession amount of the tokens; however, other combined information may be outputted.

Additionally, in the present embodiment, in a case of determining the consumption rule (the distribution method) of the untransferable token 7 and the transferable token 5, if one of the untransferable token 7 or the transferable token 5 is drained, the consumption processing unit 73 consumes the other; however, treating of a distribution method other than the above may be determined. For example, the distribution method may be determined such that the untransferable token 7 and the transferable token 5 are consumed in parallel at a predetermined ratio different from each other. Additionally, for example, an upper limitation or a lower limitation of the consumption of the untransferable token 7 or transferable token 5 may be determined. Moreover, the transferable token 5 may be set not to be consumed even if the consumption amount is in a shortage when the untransferable token 7 is drained (and vice versa).

1. A token generation apparatus configured to generate a token relating to predetermined assets, the token which is issued at a predetermined value, is associated with a paid token relating to the assets, and is different from the paid token, comprising a smart contract that includes:
a non-paid token consumption history storage unit configured to store history of consumption and a purpose of the assets in the token; and
a consumption processing unit configured to accept designation of a consumption amount and a purpose of the assets and configured to store, into the history of consumption, information indicating that the assets of the designated consumption amount are consumed in the token when the accepted purpose is a predetermined purpose.

2. The token generation apparatus according to claim 1, wherein the consumption processing unit accepts designation of a consumption amount of the assets, stores, into the history of consumption, information indicating that a part of the designated consumption amount is consumed in the token, and stores, into the paid token, information indicating that the residual of the designated consumption amount is consumed in the paid token.

3. The token generation apparatus according to claim 2, wherein the consumption processing unit further accepts designation of a consumption rule relating to the token, determines consumption amounts in the paid token and the token out of the designated consumption amount, respectively, according to the designated consumption rule, stores, into the history of consumption, information indicating that the determined consumption amount of the token is consumed in the token, and stores, into the paid token, information indicating that the determined consumption amount in the paid token is consumed in the paid token.

4. The token generation apparatus according to claim 3, wherein the consumption processing unit confirms whether the designated consumption amount is greater than a current amount of the assets in the token when accepting the consumption rule in which priority of consumption in the token is higher than priority of consumption in the paid token and stores, into the history of consumption, information indicating that all the current amount of the assets is consumed in the token while storing, into the paid token, information indicating that the residual assets except the consumed current amount out of the designated consumption amount are consumed in the paid token when the designated consumption amount is greater than the current amount of the assets in the token.

5. The token generation apparatus according to claim 1, comprising:
a non-paid token information confirmation unit that accepts designation of an account and outputs information on the assets in the token associated with the designated account.

6. The token generation apparatus according to claim 1, comprising:
a paid and non-paid token information confirmation unit that accepts designation of an account and outputs information that is a combination of information on the assets in the token associated with the designated account and information on the assets in the paid token associated with the designated account.

7. A token generation method implemented by an information processing device, comprising:
generating a token relating to predetermined assets, the token which is issued at a predetermined value, is associated with a paid token relating to the assets, and is different from the paid token, comprising a smart contract, the smart contract including
a non-paid token consumption history storage unit that stores history of consumption and a purpose of the assets in the token, and
a consumption processing unit that accepts designation of a consumption amount and a purpose of the assets and stores, into the history of consumption, information indicating that the assets of the designated consumption amount are consumed in the token when the accepted purpose is a predetermined purpose.

8. The token generation method according to claim 7, wherein in the consumption processing, the information processing device accepts designation of a consumption amount of the assets, stores, into the history of consumption, information indicating that a part of the designated consumption amount is consumed in the token, and stores, into the paid token, information indicating that the residual of the designated consumption amount is consumed in the paid token.

9. The token generation method according to claim 8, wherein in the consumption processing, the information processing device further accepts designation of a consumption rule relating to the token, determines consumption amounts in the paid token and the token out of the designated consumption amount, respectively, according to the designated consumption rule, stores, into the history of consumption, information indicating that the determined consumption amount in the token is consumed in the token, and stores, into the paid token, information indicating that the determined consumption amount in the paid token is consumed in the paid token.

10. The token generation method according to claim 9, wherein in the consumption processing, the information processing device confirms whether the designated consumption amount is greater than a current amount of the assets in the token when accepting the consumption rule in which priority of consumption in the token is higher than priority of consumption in the paid token and stores, into the history of consumption, information indicating that all the current amount of the assets is consumed in the token while storing, into the paid token, information indicating that the residual assets except the consumed current amount out of the designated consumption amount are consumed in the paid token when the designated consumption amount is greater than the current amount of the assets in the token.

11. The token generation method according to claim 7, wherein the information processing device accepts designation of an account and outputs information on the assets in the token associated with the designated account.

12. The token generation method according to claim 7, wherein the information processing device accepts designation of an account and outputs information that is a combination of information on the assets in the token associated with the designated account and information on the assets in the paid token associated with the designated account.

13. A token management program which is a program of a token relating to predetermined assets, the token which is issued at a predetermined value, is associated with a paid token relating to the assets, and is different from the paid token, that causes an information processing device to execute:
non-paid token consumption history store processing to store history of consumption and a purpose of the assets in a token; and
consumption processing to accept designation of a consumption amount and a purpose of the assets and store, into the history of consumption, information indicating that the assets of the designated consumption amount are consumed in the token when the accepted purpose is a predetermined purpose.
